(19) United States
(12) Patent Application Publication
(10) Pub. No.: US 2005/0041273 A1
(43) Pub. Date: Feb. 24, 2005

(54) METHOD FOR CAPTURING A PATTERN PRINTED ON A PRINT MEDIUM AND RELATED APPARATUS

(76) Inventor: Zhi-Hai Zhang, Chiang-Su Province (CN)

Correspondence Address: (NAIPC) NORTH AMERICA INTERNATIONAL PATENT OFFICE, P.O. BOX 506, MERRIFIELD, VA, 22116, US

(21) Appl. No.: 10/711,032

(22) Filed: Aug. 18, 2004

(30) Foreign Application Priority Data
Aug. 20, 2003 (TW) 092122826

(51) Int. Cl. G02B 5/32

(52) U.S. Cl. 359/15

(57) ABSTRACT

A method for capturing a pattern, which is printed on a print medium and contains a holographic image, includes providing an image-capturing device comprising a light source for emitting light onto the print medium and a light-sensing component for receiving light reflected from the print medium, adjusting a disposition of the print medium, the light source, and the light-sensing component and equivalently locating the light-sensing component in a blind zone where the light-sensing component will not receive light reflected from the holographic image of the pattern, and capturing the pattern with the light source and the light-sensing component.

### BACKGROUND OF INVENTION

1. Field of the Invention

The present invention relates to holography, and more particularly, to a method and related apparatus for capturing a pattern printed on a print medium, the pattern comprising a holographic image.

2. Description of the Prior Art

It has been over fifty years since holography was introduced. Holography can be widely applied to a variety of fields, such as holography data access for accessing data in three-dimensions, and authentication for identification documents, securities, and lottery.

Holography relates to a method for recording a holographic image of an object by the use of diffraction and interference characteristics specialized for light. Please refer to Fig.1, which is a schematic diagram of a holographic system 10 according to the prior art. The holographic system 10 is capable of exposing a holographic image of an object 12 onto a film 14. The holographic system 10 comprises a light source 16 for emitting light and a lens module 18 for dividing light emitted from the light source 16.

The lens module 18 divides light emitted from the light source 16 into a reference light L_{ref} directly projecting onto the film 14 and an object light L_{obj} reflected by the object 12 and projecting onto the film 14. Since the reference light L_{ref} and the object light L_{obj} have a light path difference in between, an interference pattern looking like an optical grating of unequal shading values will be formed on the film 14. In detail, if the reference light L_{ref} and the object light L_{obj} the film 14 receives at point A have the light path difference a multiple of times as long as a wavelength of the light emitted by the light source 16, a light spot of construction interference will be formed on point A. On the contrary, a dark spot of destruction interference will be formed on point B if what is received on point B is the reference light L_{ref} and the object light L_{obj} having a light path difference of (m+½) times as long as the wavelength of the light emitted by the light source 16. Collecting all of light spots and dark spots forms a holographic image of the object 12 on the film 14.

In the holographic system 10 shown in FIG. 1, the light source 16, the object 12 and the film 14 are relatively still during an image formation process for forming the object 12 onto the film 14. Each of the points on the film 14 will receive light reflected from all of the shining points of the object 12 shined by light and therefore contains patterns on all of the points of the object 12. Alternatively, the light source 16 can selectively move from an initial position to a certain position and emit light onto the object 12 and onto the film 14 simultaneously and expose a first pattern corresponding to the initial position as well as a second pattern corresponding to the certain position onto the film 14 sequentially. People moving from a first position to a second position will perceive two distinct patterns of the object 12 to be shown on the film 14 due to the reversibility characteristic of light.

Since people standing on two distinct positions and looking at a holographic image having a plurality of patterns will preserve two different images, the holography technology can be applied to encryption. For example, a genuine document, which is printed on a printing medium, contains a first holographic image, which is formed by projecting the light emitted from the light source 16 and reflected from the object 12 onto the printing medium. If a counterfeit document containing a second holographic image tries to mix the fake with the genuine, and since a second incident angle of the light emitted by the light source 16 onto the film 14 in the process of forming the second holographic image is not always equal to a first incident angle of the light emitted by the light source 16 onto the film 14 in the process of forming the first holographic image, a counterfeit copy document formed by an image capturing device through the use of copying the counterfeit document will not be identical to a genuine copy document formed by the image capturing device through the use of copying the genuine document.

Although the genuine document having the first holographic image printed is hard to be counterfeited, the first holographic image however makes the genuine document having a part covered by the first holographic image unreadable.

### SUMMARY OF INVENTION

It is therefore a primary objective of the claimed invention to provide a method for capturing a pattern rather than a holographic image, both of which are printed on a printing medium.

According to the claimed invention, the method includes providing an image-capturing device comprising a light source for emitting light onto the print medium and a light-sensing component for receiving light reflected from the print medium, adjusting a disposition of the print medium, the light source, and the light-sensing component and equivalently locating the light-sensing component in a blind zone where the light-sensing component will not receive light reflected from the holographic image of the pattern, and capturing the pattern with the light source and the light-sensing component.

The disposition adjustment of the light source, the light-sensing component and the print medium can be realized by dislocating the light-sensing component and the light source and by inserting a transparent plate in between the print medium and the image-capturing device.

It is an advantage of the claimed invention that a method is capable of adjusting the disposition of the light source, the print medium, and the light-sensing component and of controlling the light-sensing component not to receive light reflected from the holographic image but to receive light from the pattern only.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a holographic system according to the prior art.

FIG. 2 is a schematic diagram showing how a holographic image reflects light emitted by a light source located on an initial position according to the present invention.

FIG. 3 is a schematic diagram showing how the holographic image shown in FIG. 2 reflects light emitted by the light source moved to a predetermined position according to the present invention.

FIG. 4 is a flowchart of a method of the preferred embodiment for capturing a pattern printed on a print medium shown in FIG. 5 according to the present invention.

FIG. 5 is a schematic diagram of an image-capturing apparatus of the preferred embodiment according to the present invention.

FIG. 6 is a first state diagram of the image-capturing apparatus shown in FIG. 5 according to the present invention.

FIG. 7 is a second state diagram of the image-capturing apparatus shown in FIG. 5 according to the present invention.

FIG. 8 is a third state diagram of the image-capturing apparatus shown in FIG. 5 according to the present invention.

FIG. 9 and FIG. 10 are two side elevational views of an image-capturing apparatus of a second embodiment according to the present invention.

### DETAILED DESCRIPTION

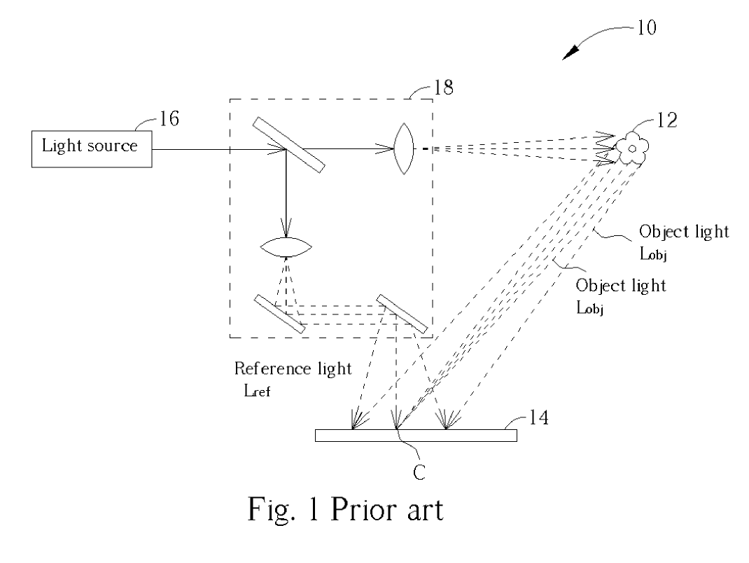

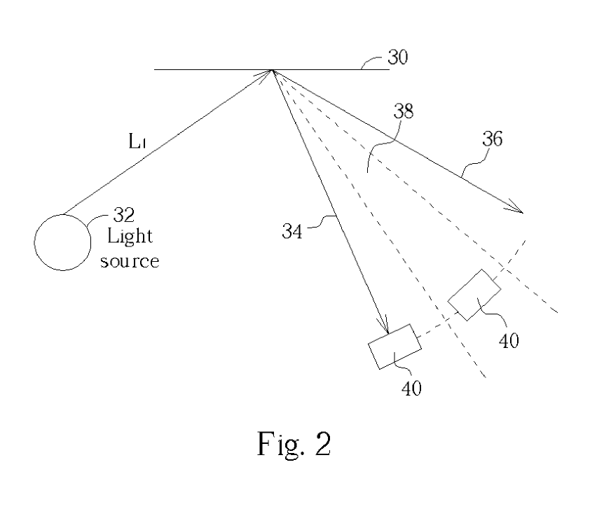

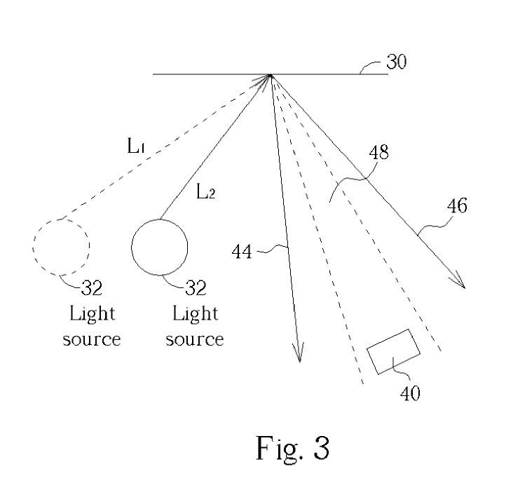

Please refer to FIG. 2 and FIG. 3. FIG. 2 is a schematic diagram showing how a holographic image 30 reflects light L₁ emitted by a light source 32 located on an initial position according to the present invention. FIG. 3 is a schematic diagram showing how the holographic image 30 reflects light L₂ emitted by the light source 32 moved to a predetermined position according to the present invention. During the image formation process for exposing the holographic image 30 onto the film 14 as shown earlier in FIG. 1, the light source 16 is capable of moving from the initial position to the certain position and exposing the object 12 of two distinct patterns onto the film 14 and forming the holographic image 30. Conversely, the holographic image 30 reflects the light L₁ emitted by the light source 32 shown in FIG. 2 onto to a variety of regions, such as a first region 34 and a second region 36, and forms distinct images onto the first region 34 and the second region 36 respectively. On the other hand, the holographic image 30 reflects the light L₂ emitted by the light source 32 (having moved from a first position shown in FIG. 2 to a second position shown in FIG. 3) shown in FIG. 3 onto to another varieties of regions, such as a third region 44 and a fourth region 46, and forms distinct images onto the third region 44 and the fourth region 46 respectively. The holographic image 30 is a combination of these images formed on these four regions 34, 36, 44 and 46. In other words, four distinct images are comprised in the holographic image 30 and can be perceived from these four regions 34, 36, 44 and 46. Therefore, a light-sensing component 40 on an initial position in the first region 34 (36, 44 and 46) can receive light reflected from the holographic image 30.

In FIG. 2 and FIG. 3, a blind zone 38 is formed in between the first region 34 and the second region 36, and a second blind zone 48 is formed in between the third region 44 and the fourth region 46. The holographic image 30 will not reflect the light La emitted by the light source 32 onto the first blind zone 38. Equivalently, as far as the light L₁ emitted by the light source 32 located on the initial position is concerned, the light-sensing component 40 moved from the initial position (the first region 34) to the first blind zone 38 (a predetermined position for the light-sensing component 40) will not receive “any” light reflected from the holographic image 30 (Precisely speaking, the light-sensing component 40 on the first blind zone 38 still has a chance to receive light reflected from the holographic image 30 and light diffused from a region outside of the first blind zone 38. However, the light that the light-sensing component 40 on the first blind zone 38 actually receivess is always less than a predetermined level in brightness. In practice, under a circumstance that the light-sensing component 40 on the first blind zone 38 does not receive any light reflected from the holographic image 30, the light-sensing component 40 will receive nothing but the patterns printed on a print medium. Even if the light-sensing component 40 has received some light reflected from the holographic image 30, the light will be no more than the predetermined level in brightness and has only a slight influence on the clearness of the patterns printed on the print medium.) Similarly, the holographic image 30 will not reflect the light L₂ emitted by the light source 32 onto the second blind zone 48 either. Equivalently, as far as the light L₂ emitted by the light source 32 moved from the initial position to the predetermined position is concerned, the light-sensing component 40 located on the initial position will not receive any light reflected from the holographic image 30. In summary, by adjusting the disposition of a light-sensing component and a light source, an image-capturing apparatus is capable of selectively capturing a holographic image of a pattern or a blank corresponding to a blind zone. Therefore, what the image-capturing apparatus captures can only comprise patterns printed on a print medium and a holographic image of a blank.

The method of the present invention is to guide light emitted by the light source 32 onto the holographic image 30 (the holographic image 30 further comprises an image printed on a print medium) to a region (blind region) where the light-sensing component 40 is not located. Therefore, the light-sensing component 40 will not receive any light reflected from any image of the holographic image 30. Equivalently, patterns printed on the print medium that the light-sensing component 40 has captured do not contain the holographic image 30.

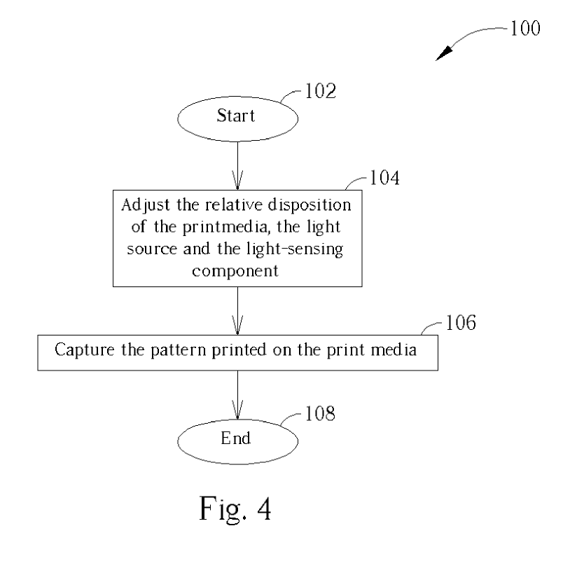

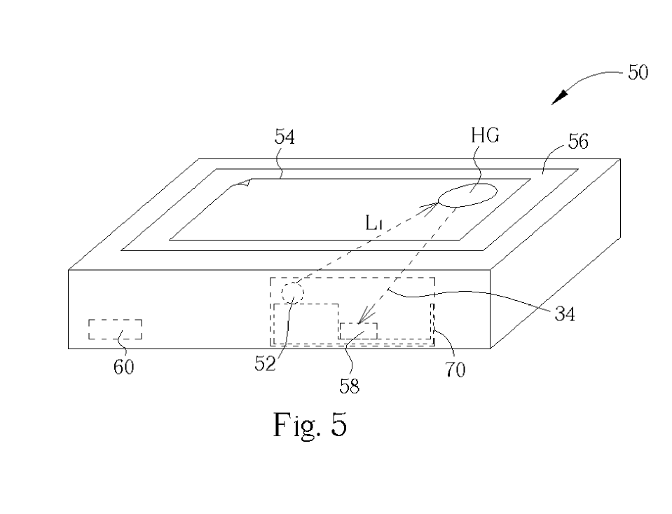

Please refer to FIG. 4 and FIG. 5. FIG. 4 is a flowchart of a method 100 of the preferred embodiment for capturing a pattern printed on a print medium 54 (shown in FIG. 5) according to the present invention. The pattern comprises a holographic image HG. FIG. 5 is a schematic diagram of an image-capturing apparatus 50 of the preferred embodiment according to the present invention. The image-capturing apparatus 50 comprises an image-capturing module 70, a transparent platform 50 for the print medium 54 to be placed on, and a logic unit 60. The image-capturing module 70 comprises a movable light source 52 for emitting light and a movable light-sensing component 58 for receiving light reflected from the print medium 54. The logic unit 60 is for controlling the light source 52 and the light-sensing component 58. The image-capturing apparatus 50 can be a scanner or a copy machine, the light-sensing component 58 can be a charge coupled diode (CCD), and the logic unit 60 can be a logic circuit or a program code stored in a memory. The method 100 comprises the following steps:

Step 102:Start;

(The print medium 54 is placed on the transparent platform 56, and the light source 52, the light-sensing component 58 and the print medium 54 are disposed according to an initial relative disposition, the print medium 54 located at a position inside a depth of field (DoF) of the light-sensing component 58 and the light source 52 as well as the light-sensing component 58 staying on an initial position respectively.)

Step 104:Adjust a relative disposition of the light source 52, the light-sensing component 58 and the print medium 54 to equivalently locate the light-sensing component 58 on a blind zone corresponding to the holographic image HG;(As shown in FIG. 2, relocating the light source 52 or the light-sensing component 58 and equivalently locating the light-sensing component 58 on the blind zone corresponding to the holographic HG prevents the light-sensing component 58 from receiving light reflected from the holographic image HG. The logic unit 60 controls the light source and/or the light-sensing component 58 to move to respective predetermined positions.)

Step 106:Capture the pattern printed on the print medium 54 with the light source 52 and the light-sensing component 58 according to the changed relative disposition of the light source 52, the light-sensing component 58 and the print medium 54;(The pattern the light-sensing component 58 therefore captures will not comprise the holographic image HG, so the light-sensing component 58 can receive nothing but the clear pattern printed on the print medium 54.)

Step 108:Ends.

(The logic unit 60 can selectively control the light source 52 and the light-sensing component 58 to move back to the initial positions.)

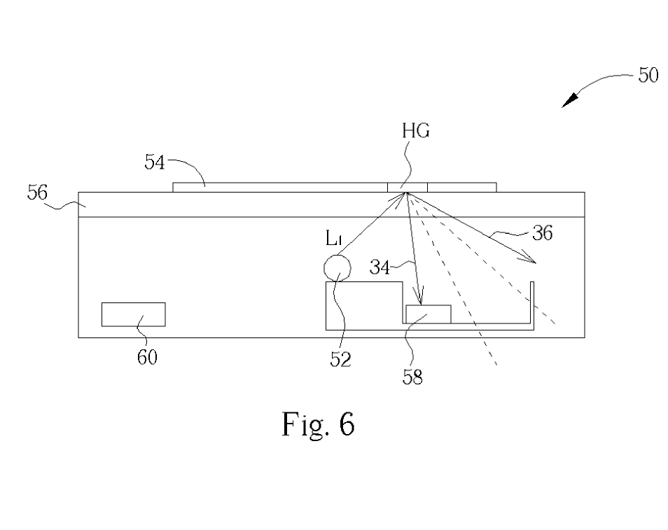

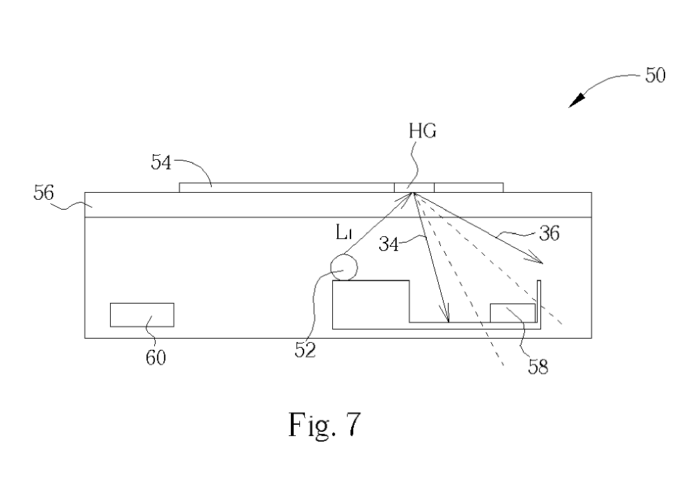

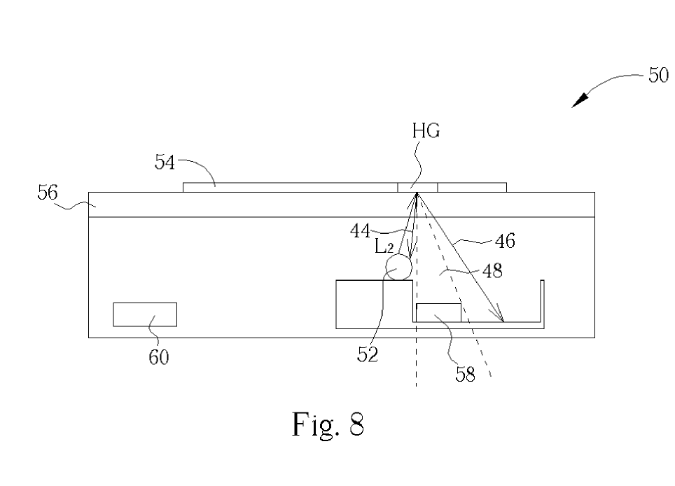

Please refer to FIG. 6 to FIG. 8 as well as FIG. 2 and FIG. 3. FIG. 6 is a side elevational view of the image-capturing apparatus 50 in step 102 of the method 100 as the light source 52, the light-sensing component 58 and the print medium 54 having the predetermined relative disposition according to the present invention, and both the light source 52 and the light-sensing component 58 being located on the initial positions. FIG. 7 is a side elevational view of the image-capturing apparatus 50 in step 104 of the method 100 as the light source 52, the light-sensing component 58 and the print medium 54 having the relative disposition changed according to the present invention, and the light source 52 still being located on the initial position while the light-sensing component 58 having moved to the predetermined position. FIG. 8 is a side elevational view of the image-capturing apparatus 50 in step 104 of the method 100 as the light source 52, the light-sensing component 58 and the print medium 54 having the relative disposition changed according to the present invention, and the light source 52 having moved to the predetermined position while the light-sensing component 58 still being located on the initial positions. The light-sensing component 58 shown in FIG. 7 as well as FIG. 8 is located on a position inside a blind zone corresponding to the holographic image HG.

As shown in to FIG. 7, the method 100 moves the light-sensing component 58 from the initial position to the predetermined position to prevent the light-sensing component 58 from receiving light reflected from the holographic image HG. As shown in FIG. 8, the method 100 moves the light source 52 from the initial position to the predetermined position to prevent the light-sensing component 58 from receiving light reflected from the holographic image HG.

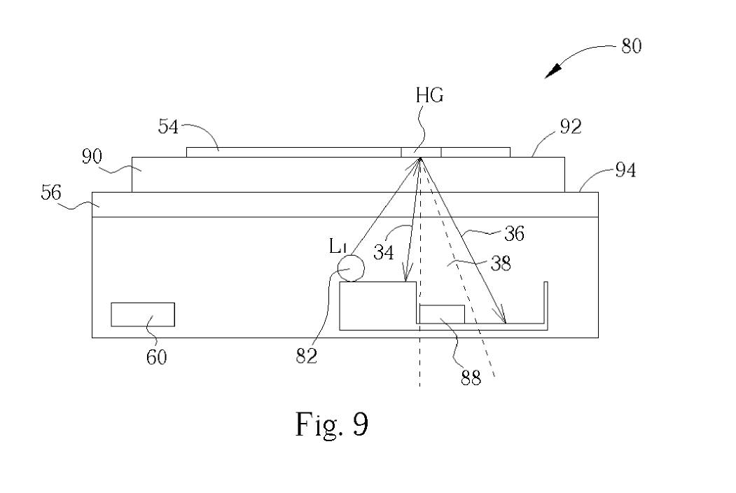

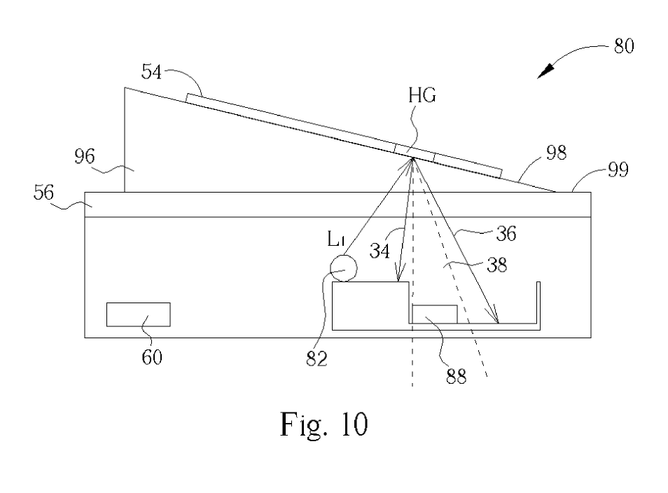

Both the light source 52 and the light-sensing component 58 the image-capturing apparatus 50 comprises are movable. An image-capturing apparatus of the present invention can alternatively comprise a relatively stationary light source and a light-sensing component. Please refer to FIG. 9 and FIG. 10, which are two side elevational views of an image-capturing apparatus 80 of a second embodiment according to the present invention. The image-capturing apparatus 80 comprises a light source 82, the transparent platform 56, a light-sensing component 88 and the logic unit 60. In contrast to the image-capturing apparatus 50 comprising the movable light source 52 and the movable light-sensing component 58, the image-capturing apparatus 80 comprises the stationary light source 82 and the stationary light-sensing component 88. In addition, the image-capturing apparatus 80 further comprises an adaptor 90 (an adaptor 96 for the image-capturing apparatus 80 shown in FIG. 10) for changing the relative disposition of the light source 82, the light-sensing component 88 and the print medium 54. The adaptor 90, 96 can be a transparent plate 160 centimeters long and 130 centimeters wide.

The transparent plate 90 shown in FIG. 9 comprises a first surface 92 for the print medium 54 to be placed on, and a second surface 94 in parallel with the first surface 92. The transparent plate 96 shown in FIG. 10 comprises a first surface 98 for the print medium 54 to be placed on, and a second surface 99 oblique to the first plate 98. In the second embodiment of the present invention, the transparent plate 90 shown in FIG. 9 is six centimeters thick, and the transparent plate 96 shown in FIG. 10 has a first end three centimeters thick and a second end of eight centimeters thick.

In contrast to the prior art, the present invention can provide a method for capturing a pattern printed on a print medium by adjusting the disposition of the light source 52, the print medium 54 and the light-sensing component 58 according to a certain angle corresponding to a certain pattern of a plurality of patterns included in a holographic image HG printed on the print medium 54 to control the light-sensing component 58 not to receive light reflected from the holographic image HG and not to receive the holographic image HG but instead to receive light from the pattern printed on the print medium 54.

Those skilled in the art will readily observe that numerous modifications and alterations of the device and method may be made while retaining the teachings of the invention. Accordingly, the above disclosure should be construed as limited only by the metes and bounds of the appended claims.

1. A method for capturing a pattern printed on a print medium, the pattern comprising a holographic image and the method comprising following steps:
(a) providing an image-capturing device comprising a light source for emitting light onto the print medium and a light-sensing component for receiving light reflected from the print medium;
(b) adjusting a disposition of the print medium, the light source and the light-sensing component, and equivalently locating the light-sensing component in a blind zone where the light-sensing component will not receive light reflected from the holographic image of the pattern; and
(c) capturing the pattern with the light source and the light-sensing component.

2. The method of claim 1 wherein adjusting the disposition of the light source, the light-sensing component and the print medium is realized by relocating the light-sensing component.

3. The method of claim 1 wherein adjusting the disposition of the light source, the light-sensing component and the print medium is realized by relocating the light source.

4. The method of claim 1 wherein adjusting the disposition of the light source, the light-sensing component and the print medium is realized by installing a transparent plate between the print medium and the image-capturing device.

5. The method of claim 4 wherein the transparent plate comprises a first surface for the print medium to be placed on and a second surface disposed in parallel with the first surface.

6. The method of claim 4 wherein the transparent plate comprises a first surface for the print medium to be placed on and a second surface oblique to the first surface.

7. A device for implementing the method of claim 1.

8. The method of claim 1 further comprising:
providing the image-capturing device with a logic unit for adjusting a disposition of the light source and the light-sensing component.

9. The method of claim 8 wherein the logic unit is a logic circuit.

10. The method of claim 8 wherein the logic unit is a program code stored in a memory device.

11. The method of claim 8 wherein the light-sensing component source is movable and the logic unit is capable of controlling the light-sensing component to move to a predetermined position.

12. The method of claim 8 wherein the light source is movable and the logic unit is capable of controlling the light source to move to a predetermined position.

13. An image-capturing device for capturing a pattern printed on a print medium, the pattern comprising a holographic image and the image-capturing device comprising:
a transparent plate for the print medium to be placed on;
a light source for emitting light onto the print medium;
a light-sensing component for receiving light reflected from the print medium; and
an adaptor installed between the transparent plate and the print medium for changing a disposition of the print medium, the light source and the light-sensing component, and for equivalently locating the light-sensing component in a blind zone where the light-sensing component will not receive light reflected from the holographic image of the pattern.

14. The method of claim 13 wherein the adaptor is a transparent plate.

15. The method of claim 14 wherein the transparent plate comprises a first surface for the print medium to be placed on and a second surface disposed in parallel with the first surface.

16. The method of claim 15 wherein the transparent plate is six millimeters thick.

17. The method of claim 14 wherein the transparent plate comprises a first surface for the print medium to be placed on and a second surface oblique to the first surface.

18. The method of claim 17 wherein the transparent plate has a first end three millimeters thick and a second end eight millimeters thick.

19. An adaptor for an image-capturing device capable of capturing a pattern printed on a print medium, the pattern comprising a holographic image, the image-capturing device comprising:
a transparent plate;
a light source; and
a light-sensing component; and
the adaptor comprising:
a first surface for the print medium to be placed on; and
a second surface installed on a first side of the first surface according to a predetermined rule for contacting with the transparent plate;
wherein the adaptor is capable of adjusting a disposition of the print medium, the light source and the light-sensing component, and of equivalently locating the light-sensing component in a blind zone where the light-sensing component will not receive light reflected from the holographic image of the pattern.

20. The method of claim 19 wherein the adaptor is a transparent plate.

21. The method of claim 20 wherein the first surface is parallel to the second surface.

22. The method of claim 21 wherein the transparent plate is six millimeters thick.

23. The method of claim 19 wherein the first surface is oblique to the second surface.

24. The method of claim 23 wherein the transparent plate has a first end three millimeters thick and a second end eight millimeters thick.
